(19) United States
(12) Patent Application Publication
(10) Pub. No.: US 2020/0324662 A1
(43) Pub. Date: Oct. 15, 2020

(54) Device, system and method for storing, safeguarding and maintaining a mobile robot

(71) Applicant: STARSHIP TECHNOLOGIES OÜ, Tallinn (EE)

(72) Inventors: Lauri VÄIN, Tallinn (EE); Tommy BIENE, Tallinn (EE); Ronald TOMMEPÕLD, Tallinn (EE); Rene RAASUKE, Tallinn (EE); Viljar VALDEK, Keila (EE); Henrik HERRANEN, Tallinn (EE); Antti MÄKELA, Helsinki (FI); Mikko SEPPÄNEN, Helsinki (FI); Vahur LAAS, Tallinn (EE); Kaspar LAURI, Tallinn (EE)

(21) Appl. No.: 16/860,779

(22) Filed: Apr. 28, 2020

Related U.S. Application Data
(63) Continuation of application No. PCT/EP2018/080023, filed on Nov. 2, 2018.

(30) Foreign Application Priority Data
Nov. 3, 2017 (EP) 17200025.9

(51) Int. Cl. B60L 53/36; G05D 1/02; B60L 53/31

(52) U.S. Cl. CPC B60L 53/36; B60L 53/31; G05D 1/0225

(57) ABSTRACT

Disclosed is a storage device configured to store, maintain and shelter a mobile robot. The storage device comprises a housing, a port, a battery station, a processing component and a communication component. Also disclosed is a system configured to store, maintain and shelter a mobile robot. The system comprises the storage device, a mobile robot and a server. Also disclosed is a method for at least one of storing and maintaining a mobile robot.

### RELATED APPLICATIONS

This application is a continuation of PCT/EP2018/080023, filed Nov. 2, 2018 and which claims priority from European patent application No. 17200025.9, filed Nov. 3, 2017, the entire contents of each of which are hereby fully incorporated herein by reference for all purposes.

### FIELD

The invention is directed towards a device, system and method for sheltering, storing and maintaining a mobile robot. The invention is also directed towards providing a base or a pod for a mobile robot to be stored at and to preferably be maintained at. The invention is also directed towards a structure configured to house a mobile robot and preferably comprising a mobile robot battery exchange station and calibration.

### INTRODUCTION

Mobile robots are increasingly being used for different purposes in day to day life. The robots can comprise sensors used for navigation, situational awareness and other tasks and allowing them to operate at least semi-autonomously. Recently, mobile robots have been increasingly used outdoors for varying tasks such as carrying items between destinations. For example, mobile robots are used to deliver packages, groceries or meals and for other related purposes. Such mobile robots can be stored indoors to prevent theft, vandalism or damage due to weather. The robots can be stored in existing buildings, but this can require special infrastructure added to them or a supervising person to make sure the robots are in place.

Furthermore, apart from storage and shelter, the robots may need to be maintained when not in use. Such maintenance can include calibrating the robot's sensors, exchanging the robot's power source, saving or forwarding data, or running diagnostics.

For example, US patent application 2009/0254218 A1 discloses a lawnmower that can optionally comprises a dock or a home base with an optional battery charging device.

Mobile robots configured to transport items may need to travel in outdoors surroundings and it can be advantageous to provide a storage device optimized for storage, shelter, maintenance and/or reloading for mobile robots configured to operate outdoors and to transport items in unstructured outdoors environments.

### SUMMARY

In light of the above, it is the object of the present invention to disclose devices, systems and methods for storing, safeguarding and maintaining mobile robots, preferably in outdoor environments. It is also the object of the present invention to disclose a device configured to allow entry to mobile robots and to be otherwise inaccessible for ingress. It is also the object of the present invention to improve item transport in outdoors environments and to provide a specialized storage and maintenance storage device for mobile robots performing such item transport.

In a first embodiment, a storage device configured to store, maintain and shelter a mobile robot is disclosed. The storage device comprises a housing comprising an enclosed space configured to house at least one mobile robot. The storage device further comprises a port located in the housing and configured to open to let the mobile robot enter or exit the enclosed space of the housing. The storage device also comprises a battery station configured to swap a battery of the mobile robot, a processing component and a communication component.

The storage device can also be referred to as a pod herein. It can be a free standing outdoor or indoor device, or it can be integrated into a building and/or removably attached to a building. The storage device can be particularly useful to house and maintain mobile robots configured to transport items. Such mobile robots can deliver packages, groceries, act as mobile kiosks or vending machines and perform other tasks related to item transportation. The robots can preferably operate outdoors. The storage device can serve to provide a shelter for these robots where they can be stored during downtime and/or maintained during operation. The storage device can then contribute to the efficiency and reliability of the operation of the mobile robots transporting items. The storage device can preferably be autonomous, and therefore can be operated at any time of day. Furthermore, the storage device can preferably be compact, so that it can be integrated into the outdoor surroundings organically. For example, the pod can be placed near bus stops, parking meters, streetlights, post boxes, mailboxes, vending machines, benches, ATMs and other common elements of street architecture. The storage device can even be integrated with some of these elements, for example ATMs or vending machines.

In some embodiments, the housing can at least partially comprise a material permeable to electromagnetic waves in the radio spectrum. In some such embodiments, the permeable material can comprise an area of at least 50 by 50 cm, preferably at least 80 by 80 cm on the housing. This can be particularly advantageous to allow the robot to communicate with outside sources (such as an external server for example) while located in the storage device.

In some embodiments, the housing can comprise at least one of a polymer-based material and a composite of polymer and mineral material. This can be, for example Corian®. Usage of such material can be preferably, since it is permeable to the radio waves, durable, aesthetically appealing and resilient (including to water, dust, dirt and other substances).

In some embodiments, the port can be configured to be autonomously opened and closed. That is, the port can comprise motors that can open and close it without manual assistance. The opening and closing can be controlled by the processing component or by external devices via the communication component. The port can also be configured to be locked and unlocked autonomously.

In some embodiments, the port can be configured to open and close vertically or horizontally in the plane of the port. That is, the port can open akin to a garage door, or a sliding door, and not like a typical apartment or room door. The plane of the port refers to the plane of the side of the storage device housing where the port is located. This configuration of the port can be particularly advantageous, since it would avoid a risk of the door hitting parked cars, passersby, animals or other objects when opening and closing. Furthermore, it contributes to a more compact size of the pod. Even further, the port can be more securely locked in this configuration. In some such embodiments, the port can comprise at least one of a plurality of slats and mesh. That is, the port can comprise a plurality of interconnected slats that can allow for flexibility, so that the slats can retract into the storage device (along its ceiling or side) when the port is opening. The mesh can comprise a metal mesh or a polymer mesh that is durable enough to withstand weather conditions and/or vandalism. The port can also comprise other types of configurations provided they allow for a vertical or horizontal opening without substantially protruding beyond the storage device.

In some embodiments, the battery station can be located on the floor of the storage device and comprise a ramp for the mobile robot to climb it. The robot can enter the pod directly climbing onto the battery station. This can allow to optimize the space inside the pod, and therefore minimize its overall dimensions. The battery station can be inbuilt into the housing, or, preferably, be placed on or removably fixed to the floor of the enclosed space of the storage device.

In some embodiments, the battery station can comprise additional batteries and be configured to load the robot with them. That is, the battery station can swap or replace the robot's empty (or not full) battery, with a fully (or mostly) charged one.

In some embodiments, the battery station can be further configured to at least one of charge the battery of the mobile robot and charge additional batteries. That is, the battery station can have one or a plurality of charging stations, where batteries that are not fully charged can be placed for charging. The battery station can be configured to do this autonomously.

In some embodiments, the processing component can be configured to control the opening and closing of the port. That is, the port can be opened and closed autonomously, upon a command from the processing component. Note, that autonomously refers herein to opening and closing without manual assistance from a human.

In some embodiments, the communication component can be configured to communicate with the mobile robot. This can be advantageous to authenticate the robot to the storage device and vice versa, exchange data relating to the robot aligning for entry to the storage device, exchange data related to maintenance and/or further communication.

In some embodiments, the processing component can be configured to open the port upon the communication component receiving a request from the robot to do so. That is, the robot and the storage device can communicate via communication components, with this communication analyzed by the processing component and taking an action (such as opening the port) based on it. The communication can be direct, or indirect, through a server.

In some embodiments, the storage device can further comprise at least one illumination component. The illumination component can be preferably placed on the outside of the storage device. In some such embodiments, the illumination component can comprise one or a plurality of LED lights configured to at least partially illuminate the outside of the housing. This can be advantageous to detect the surroundings of the storage device, any potential intruders or vandals, any changes in the surroundings due to weather (such as a puddle forming in front of the port). Furthermore, the robot can use the illumination to identify the storage device and port easier. The illumination component can also be used for communication with humans, for example to give warning signals.

In some embodiments, the storage device can further comprise at least one detection sensor located on the outside of the housing and configured to detect surroundings of the storage device. In some such embodiments, the detection sensor can comprise at least one of a combination of a visual sensor, an infrared sensor, a temperature sensor, a smoke detector, an accelerometer, a gyroscope, a flood detector and/or an infrared detector. Such sensors can be useful to evaluate any threats or changes in circumstances or surroundings around the storage device.

In some embodiments, the storage device can further comprise at least one diagnostic sensor located on the inside of the housing and configured to inspect at least one of the mobile robot and the inside of the storage device. In some such embodiments, the diagnostic sensor can comprise at least one of a visual sensor, an infrared sensor, a temperature sensor, a smoke detector, an accelerometer, a gyroscope, a flood detector and/or an infrared detector and a humidity sensor. The diagnostic sensor can help to run any maintenance procedures on the robot. It can also help to monitor the physical conditions inside the enclosed space, to ensure that they are suitable for the mobile robot and for the operation of any electronics and/or sensors and/or other components located inside the storage device. In some such embodiments, the diagnostic sensor can be configured to detect the visual appearance of the mobile robot. That is, dirt, damage or other irregularities in the appearance of the mobile robot can be detected by the diagnostic sensor (with the data being processed by the processing component or sent off-site via the communication component). The diagnostic sensor can further be configured to detect any foreign objects that have entered the storage device. For example, a cat or another animal entering the pod alongside the mobile robot would be detected and subsequently released via the port.

In some embodiments, the storage device can further comprise at least one calibration component configured to calibrate sensors of the mobile robot. The calibration component can comprise, for example, a calibration pattern that can be used to calibrate a plurality of the robot's cameras.

In some embodiments, the storage device can further comprise a communication terminal comprising at least one of a display, a microphone and a speaker configured for communication with third parties. The communication terminal can comprise a display with a touchscreen, where curious passersby can request information regarding the storage device and/or the mobile robot. The communication terminal can be useful to communicate with passersby and/or potential vandals, particularly via a speaker.

In some embodiments, the storage device can further comprise a temperature control component configured to actively or passively control the temperature within the enclosed space of the housing. The temperature control component can comprise convective or active ventilation component, an air conditioning and/or a heating component. The temperature control component can also comprise a plurality of devices. For example, a localized heater can be present for deicing of the mobile robot during cold weather.

In some embodiments, the storage device can further comprise an energy generating component. In some such embodiments, the energy generating component can comprise at least one of a solar panel and a wind turbine. The energy generating component can be particularly useful for the cases where the storage device is not connected to the local electrical grid. Additionally or alternatively, the energy generating component can ensure self-sufficiency of the storage device.

In some embodiments, the storage device can further comprise a housing bottom part configured to be engaged and transported by standard transporting equipment. That is, the bottom part can be manufactured with gripping elements such as grooves or protrusions that can be easily gripped onto.

In some embodiments, the storage device can comprise a length of 100 to 1500 cm, preferably 500 to 1200 cm, a height of 300 to 1000 cm, preferably 500 to 800 cm, and a width of 300 to 1500 cm, preferably 500 to 1000 cm. That is, the storage device can be relatively compact and blend into outdoor environments such as streets, public spaces, parking lots, and other similar spaces easily and organically.

In some embodiments, the storage device can be configured to fit at least two mobile robots simultaneously.

In some embodiments, the storage device can be configured to fit up to five mobile robots simultaneously. This can be done side by side and/or on top of each other with a ramping system, an elevator and/or another device to lift and lower the robots.

In some embodiments, the storage device can further comprise an identification component. The identification component can comprise a code, such as a barcode, a QR code, an ArUco code and/or a similar code. The identification component can also comprise an electronic device, such as an RFID tag. The identification component can be advantageously used by the robot to identify the correct storage device that it should enter.

In some embodiments, the storage device can comprise a second port located in the housing on the opposite side of the first port and configured to open and close autonomously. This can be particularly advantageous for the storage device configured to contain a plurality of robots, since they can enter and exit on two sides of the storage device.

In some embodiments, the storage device can further comprise a public use device. In some such embodiments, the public use device can comprise at least one of a vending machine, a newspaper dispenser, an ATM, a billboard, a plant container and a bench. Integrating or combining the storage device with the public use device can be advantageous for optimizing space taken on a street or in a public space or for organically integrating the storage device with its surroundings. Furthermore, since the storage device is preferably located close to the ground (so that the mobile robot can easily access it), the public use device can be placed higher up, such as on top of the storage device or at least displaced horizontally from the ground with respect to it, so that it can be easier seen and/or accessed by humans.

In some such embodiments, the public use device can be located in the top part of the body. As mentioned above, this can ensure that it is easily accessible for the potential user.

In some such embodiments, the public use device can be displaced from the bottom of the storage device by at least one third of its height. That is, the public use device can be placed on the body of the storage device or parallel to it starting from at least a third of the storage device's height.

In a second embodiment, a storage system configured to store, maintain and shelter a mobile robot is disclosed. The storage system comprises a storage device according to any of the previously described embodiments (and including the detailed embodiments as described below). The storage system also comprises a mobile robot comprising a body comprising an item space, a battery, a robot processing component, and a robot communication component. The storage system further comprises a server, which is configured to communicate with the storage device and with the mobile robot.

In some embodiments, the storage device can be configured to replace the battery of the mobile robot. This can be advantageous, as it can allow the mobile robot to continue its operations such as transporting items, delivering packages and groceries, vending items and other operations.

In some embodiments, the mobile robot can be configured to navigate to the storage device by using the robot processing component. That is, the mobile robot can be configured to navigate at least partially autonomously, preferably semi-autonomously or autonomously in preferably outdoors environments to arrive to the storage device.

In some embodiments, the mobile robot can be configured to request access to the storage device by using the robot communication component. In some such embodiments, the mobile robot can be configured to communicate with the server to request access to the storage device and the server can be configured to communicate with the storage device to request the storage device to open the port. In other such embodiments, the mobile robot can be configured to communicate with the storage device to request access and the storage device can be configured to communicate with the server to authorize the request. That is, different configurations of communication within the system are possible. The server being the central communication point (that is, the robot and the storage device communicating through the server) can be advantageous to achieve central management of the system and to keep track of a plurality of mobile robots and storage devices operating in different or close locations. The storage device being the central communication point (that is, the robot and the server communicating through the storage device) can be advantageous in cases where the robot has no or weak network connection in the location of the storage device, and the storage device has a better connection to the network (such as a wired connection). That is, either of the two communication configurations can be useful in different circumstances.

In some embodiments, the mobile robot can be configured to detect the identification component of the storage device. That is, the mobile robot can use its sensors to visually or otherwise identify the storage device to confirm that it is the storage device that it should enter.

In some embodiments, the storage device can be configured to perform maintenance of the mobile robot when the mobile robot is located inside the enclosed space of the storage device. The maintenance can comprise diagnostics. The maintenance can comprise cleaning the robot, changing the robot's battery, charging the robot's battery, warming or cooling the robot, inspecting the robot for dirt or damage, calibrating the robot's sensors and other types of maintenance.

In some embodiments, the storage device can be configured to communicate to the server information relating to at least one of diagnostic status of the mobile robot, conditions inside the enclosed space of the housing, and conditions of the surroundings of the storage device. This can be useful for the server to “keep an eye” on the storage device, its surroundings and/or the robot inside it. The robot can also communicate to the server the results of diagnostic procedures.

In some embodiments, the storage system can further comprise a data storage unit. The data storage unit can be configured to receive data from the mobile robot, preferably via a short-range communication protocol. The data storage unit can be used for end of day or end of run data synchronization. In other words, the mobile robot can offload some or most of the data captured by its sensors during a day or during a run to the data storage unit. This can be done via short-range communication for increased streamlining, security and efficiency of operations. Sending large amounts of data (such as video or images captured by a plurality of the mobile robot's cameras) over a mobile communication protocol to a server can be time consuming, unreliable (in case the connection fails), cost intensive and inefficient. Therefore, transferring such sensor data to the data storage unit can be particularly advantageous.

The data storage unit can preferably be configured to store a large amount of data, such as many runs or several days' worth of mobile robot's sensor data (or on the order of 500 GB to many TB worth of data). The data storage unit may comprise one or a plurality of data storage drives. Once the data storage unit approaches its limit or a predetermined threshold, it may be taken to the vicinity of a server, where a wired or a local transfer of data can be made.

In some such embodiments, the data storage unit can be configured to be removably fitted inside the enclosed space of the storage device's housing. That is, the data storage unit can be attached to the inside space of the storage device. This can advantageously allow it to be in the immediate vicinity of the mobile robot and for the local data transfer to take place. The data storage unit may then also be removed from within the storage device, and physically brought to a location of a server, where the data may be transferred from the data storage unit to the server via wired means or wireless local connection.

Additionally or alternatively, the storage system may further comprise a data storage transport unit. The data storage transport unit may be connectable to the data storage unit (either via a wired connection and/or via a local wireless connection). The data storage transport unit can be used to transfer data from one or more of data storage unit to the server. This can be particularly advantageous, as in such embodiments, the data storage unit may remain fitted to the storage device. The data storage transport unit may comprise a hard drive or a similar device. It may first be physically brought to a location where one or more data storage units are present. The data obtained from one or more mobile robots may then be transferred from one or more data storage units to the data storage transport unit. It may then be physically brought to a location of the server, where the data can be transferred to it.

The use of the data storage transport unit may ensure the safety and efficiency of the data transfer between the data storage unit and the server. While the data storage unit may be used itself for such transfer, it may be preferable, in some embodiments, for it to remain within the storage device. It then may be advantageous to rather have the data storage transport unit brought to the data storage unit and then to the server without removing the data storage unit itself.

In some such embodiments, the data storage unit can further comprise a connection port configured to receive power from the storage device. In other words, there may be a cable connection the data storage unit to the storage device and/or to its source of energy.

In some such embodiments, the data storage unit can further comprise an identification component. The identification component can be used to verify an identity of the data storage unit. The identification component can comprise a barcode or an identification number. However, preferably, the identification component can comprise a display configured to display at least status of the data storage unit. That is, the identification component preferably displays not only an identification of the data storage unit, but characteristics such as amount of available data storage space, information on the stored data (such as which mobile robot it came from, which run or day it corresponds to and the like), internal diagnostics parameters and the like.

In some such embodiments, the data storage unit can further comprise at least one data unit sensor. Such sensor or sensors can be configured to detect physical state of environment around the data storage unit. In other words, physical parameters such as temperature, humidity, presence of smoke or so can be detected by the data unit sensor. The readings of the sensors may be compared with those of the storage device (if present) for redundancy and additional failsafe.

In some such embodiments, the data storage unit can be configured to communicate with the server. That is, the data storage unit preferably comprise two distinct communication components or a single communication component configured to operate via both short distance and long-distance protocols. For instance, the data storage unit can preferably communicate via Bluetooth, NFC or the like with the mobile robot and via mobile telecommunication networks with a server. This can allow for exchange of data and/or instructions between the server and the data storage unit. For example, most relevant data coming from the mobile robot may be transmitted to the server via the data storage unit, while the bulk of the data can remain on the data storage unit for later local transfer to a server. Additionally, the data storage unit may have a modem and may generate a local network that the mobile robot and/or the storage device may be able to connect to.

The data in the data storage unit can be encrypted in order to make unauthorized access to the data stored impossible or difficult. The date can be pre-encrypted already in the robot. However, none of these devices can in one embodiment also comprise the decoding key in order to have the encrypted data and the decrypting key in one place. Instead a decoding key can be comprised by a server to which the data from the robot or from the data storage unit is conveyed so that only locally on the server the data can be computed in a proper manner.

When data is uploaded, e.g. via a mobile connection the data storage may have, there is a smaller amount of metadata for each encrypted data file which can be used to identify the data file.

In a third embodiment, a method for at least one of storing and maintaining a mobile robot is disclosed. The method comprises providing a storage device according to any of the embodiments described above (and/or the detailed embodiments described below relating to the figures). The method also comprises the mobile robot approaching the storage device. The method further comprises the mobile robot communicating a request to access the storage device. The method also comprises the storage device opening the port to allow the robot ingress and closing it once the robot is inside. The method further comprises the storage device performing at least one maintenance operation on the mobile robot. The method also comprises communicating a request to leave the storage device. The method further comprises the storage device opening the port to allow the robot egress and closing it once the robot is outside.

In some embodiments, performing a maintenance operation comprises at least one of swapping a battery of the mobile robot, charging a battery of the mobile robot, inspecting the mobile robot visually, subjecting the mobile robot to a temperature change, providing calibration for at least one of mobile robot's sensors and cleaning the mobile robot. The maintenance operation can also comprise diagnostics, such as running a diagnostic procedure on the robot. Since maintenance and diagnostics might require some downtime, it can be advantageous to perform these when the robot is safely stored inside the storage device. This can improve the efficiency and reliability of the robot's operation.

In some embodiments, the method further comprises providing a system comprising the storage device, the mobile robot and a server as described in the above embodiments. In some such embodiments, the robot can communicate the request to access the storage device to the server, and the server can communicate the request to the storage device. In other such embodiments, the robot can communicate the request to access the storage device to the storage device, the storage device can communicate the request to the server, and the server can authorize the request before the storage device opens the port. As described above, having different communication configuration in the system can be advantageous depending on the general architecture of the system and on the network connectivity in the location of the storage device.

In some such embodiments wherein the storage device comprises an identification component, the method can further comprise, prior to the mobile robot communicating the request for access, the mobile robot identifying the storage device by detecting the identification component.

In some such embodiments, the method can further comprise the storage device reporting to the server on the status of the mobile robot and the maintenance operation to be performed once the mobile robot is inside the storage device. This can be advantageous for central coordination of the mobile robot operations and for keeping track of the mobile robot inside the storage device.

In some such embodiments, the method can further comprise the storage device communicating to the server at least one of conditions inside of the enclosed space and conditions of the surroundings of the storage device. This can help ensure that the storage device is properly maintained and that if it becomes damaged or inaccessible, no further mobile robots are directed towards it for example.

In some embodiments, the request to leave the storage device can be communicated by the mobile robot to the storage device. In other embodiments, the request to leave the storage device can be communicated by at least one of the mobile robot and the storage device to the server. In yet other embodiments, the request to leave the storage device can be communicated by the server to at least one of the mobile robot and the storage device.

In some embodiments, the method can further comprise, once the mobile robot is inside the storage device, transferring data from the mobile robot to a data storage unit fitted to the storage device. The data storage unit may be as described in the above and below embodiments. Transferring data locally from the robot to the data storage unit may be particularly advantageous, as it can allow for streamlining of data transfer and for avoiding lengthy and costly data transfer over a mobile communications network from the robot directly to a server. The transferred data may comprise most of the mobile robot's sensor readings from a run or from a day of operations. Such data can comprise visual images for example.

In some such embodiments, the method can further comprise transferring data from the data storage unit to a data storage transport unit followed by transporting the data storage transport unit to a location of a server and transferring the data to the server. This can advantageously allow to securely and efficiently transfer large amounts of data between the mobile robot (or a plurality of robots) and the server. The data can first be stored in a data storage unit, followed by collection via the data storage transport unit once a large amount of data accumulates.

The data in the data storage transport unit can also be encrypted in the manner as mentioned before.

In some embodiments, there may be a plurality of storage devices installed in a certain location (such as a local hub of operations for mobile robots). Each storage device may have its own data storage unit, which can collect data from a plurality of mobile robots. The data collected by the data storage units (as part of end of day or end of run routine for mobile robots) may regularly be transferred to a data storage transport unit for further transfer to a server. In other words, the data storage transport unit may be brought to the location with a plurality of storage devices, where it can be used to collect data from one or more of the data storage units installed in them. The data storage transport unit may then be brought to a location of a server, where this large amount of data can be transferred to the server via a wired or local wireless connection. In this way, transferring large amounts of data via long-range wireless connections can be avoided.

In a fourth embodiment, a data storage unit is disclosed. The data storage unit is configured to be fitted to a storage device according to any of the previous embodiments describing the storage device. The data storage unit comprises a data storage drive and a data unit communication component configured to communicate via at least one short-range protocol.

The data storage unit can be configured to be removably attached to inside of the storage device's enclosed space.

The data storage device can further comprise a connection port configured to receive power from the storage device. That is, the data storage device can share a power source feeding the storage device.

The data storage device according to any of the preceding four embodiments wherein the data unit communication component can be further configured to wirelessly communicate via medium and/or long-range communication protocol. That is, the data storage device can advantageously communicate via different types of protocols. This can be preferably done depending on the recipient of the communication. Preferably, short-range communication can be used to receive large amounts of data from a mobile robot using the storage device, and long-range communication can be used to receive instructions or transfer a small amount of crucial data to a remote server.

The data storage drive can be configured to store data received via the short-range protocol. That is, the drive can store data received by the data unit communication component. Preferably, large amounts of data can be stored by the data storage drive. This can be on the order of 500 GB to a few TB of data.

The mobile robot can be an autonomous or a semi-autonomous robot configured for ground-based travel. Note, that as used herein, the terms autonomous or semi-autonomous robot can be used to mean any level of automation depending on the task that the robot is performing. That is, the robot can be adapted to function autonomously or semi-autonomously for most of the tasks, but can also be remotely controlled for some other tasks. Then, the robot would be non-autonomous during the time it is controlled, and then autonomous and/or semi-autonomous again when it is no longer controlled. For example, the robot can assume any of the levels of automation as defined by the Society of Automotive Engineers (SAE), that is, the levels as given below.

Level 0-No Automation
Level 1-Driver Assistance
Level 2-Partial Automation
Level 3-Conditional Automation
Level 4-High Automation
Level 5-Full Automation

Though the levels usually refer to vehicles such as cars, they can also be used in the context of the mobile robot. That is, Level 0 can correspond to a remote terminal fully controlling the robot. Levels 1-4 can correspond to the remote terminal partially controlling the robot, that is, monitoring the robot, stopping the robot or otherwise assisting the robot with the motion. Level 5 can correspond to the robot driving autonomously without being controlled by a remote terminal such as a server or a remote operator (in this case, the robot can still be in communication with the remote terminal and receive instructions at regular intervals).

The present invention is also defined by the following numbered embodiments.

Below is a list of device embodiments. Those will be indicated with a letter “A”. Whenever such embodiments are referred to, this will be done by referring to “A” embodiments.

A1. A storage device configured to store, maintain and shelter a mobile robot, the storage device comprising

a housing comprising an enclosed space configured to house at least one mobile robot; and

a port located in the housing and configured to open to let the mobile robot enter or exit the enclosed space of the housing; and

a battery station configured to swap a battery of the mobile robot; and

a processing component; and

a communication component.

A2. The storage device according to the preceding embodiment wherein the housing at least partially comprises a material permeable to electromagnetic waves in the radio spectrum.

A3. The storage device according to the preceding embodiment wherein the permeable material comprises an area of at least 50 by 50 cm, preferably at least 80 by 80 cm on the housing.

A4. The storage device according to the preceding embodiment wherein the housing comprises at least one of a polymer-based material and a composite of polymer and mineral material. (Corian to be mentioned in description!)

A5. The storage device according to any of the preceding embodiments wherein the port is configured to be autonomously opened and closed.

A6. The storage device according to any of the preceding embodiments wherein the port is configured to open and close vertically or horizontally in the plane of the port.

A7. The storage device according to the preceding embodiment wherein the port comprises at least one of a plurality of slats and mesh.

A8. The storage device according to any of the preceding embodiments wherein the battery station is located on the floor of the storage device and comprises a ramp for the mobile robot to climb it.

A9. The storage device according to any of the preceding embodiments wherein the battery station comprises additional batteries and is configured to load the robot with them.

A10. The storage device according to any of the preceding embodiments wherein the battery station is further configured to at least one of charge the battery of the mobile robot and charge additional batteries.

A11. The storage device according to any of the preceding embodiments wherein the processing component is configured to control the opening and closing of the port.

A12. The storage device according to any of the preceding embodiments wherein the communication component is configured to communicate with the mobile robot.

A13. The storage device according to the preceding embodiment wherein the processing component is configured to open the port upon the communication component receiving a request from the robot to do so.

A14. The storage device according to any of the preceding embodiments further comprising at least one illumination component.

A15. The storage device according to the preceding embodiment wherein the illumination component comprises one or a plurality of LED lights configured to at least partially illuminate the outside of the housing.

A16. The storage device according to any of the preceding embodiments further comprising at least one detection sensor located on the outside of the housing and configured to detect surroundings of the storage device.

A17. The storage device according to the preceding embodiment wherein the detection sensor comprises at least one of a combination of a visual sensor, an infrared sensor, a temperature sensor, a smoke detector, an accelerometer, a gyroscope, a flood detector and/or an infrared detector.

A18. The storage device according to any of the preceding embodiments further comprising at least one diagnostic sensor located on the inside of the housing and configured to inspect at least one of the mobile robot and the inside of the storage device.

A19. The storage device according to the preceding embodiment wherein the diagnostic sensor comprises at least one of a visual sensor, an infrared sensor, a temperature sensor, a smoke detector, an accelerometer, a gyroscope, a flood detector, an infrared detector and a humidity sensor.

A20. The storage device according to any of the two preceding embodiments wherein the diagnostic sensor is configured to detect the visual appearance of the mobile robot.

A21. The storage device according to any of the preceding embodiments further comprising at least one calibration component configured to calibrate sensors of the mobile robot.

A22. The storage device according to any of the preceding embodiments further comprising a communication terminal comprising at least one of a display, a microphone and a speaker configured for communication with third parties.

A23. The storage device according to any of the preceding embodiments further comprising a temperature control component configured to actively or passively control the temperature within the enclosed space of the housing.

A24. The storage device according to any of the preceding embodiments further comprising an energy generating component.

A25. The storage device according to the preceding embodiment wherein the energy generating component comprises at least one of a solar panel and a wind turbine.

A26. The storage device according to any of the preceding embodiments further comprising a housing bottom part configured to be engaged and transported by standard transporting equipment.

A27. The storage device according to any of the preceding embodiments comprising a length of 100 to 1500 cm, preferably 500 to 1200 cm, a height of 300 to 1000 cm, preferably 500 to 800 cm, and a width of 300 to 1500 cm, preferably 500 to 1000 cm.

A28. The storage device according to any of the preceding embodiments configured to fit at least two mobile robots simultaneously.

A29. The storage device according to any of the preceding embodiments configured to fit up to five mobile robots simultaneously.

A30. The storage device according to any of the preceding embodiments further comprising an identification component.

A31. The storage device according to any of the preceding embodiments comprising a second port located in the housing on the opposite side of the first port and configured to open and close autonomously.

A32. The storage device according to any of the preceding embodiments further comprising a public use device.

A33. The storage device according to the preceding embodiment wherein the public use device comprises at least one of a vending machine, a newspaper dispenser, an ATM, a billboard, a plant container and a bench.

A34. The storage device according to any of the two preceding embodiments wherein the public use device is located in the top part of the body.

A35. The storage device according to any of the three preceding embodiments wherein the public use device is displaced from the bottom of the storage device by at least one third of its height.

Below is a list of system embodiments. Those will be indicated with a letter “S”. Whenever such embodiments are referred to, this will be done by referring to “S” embodiments.

S1. A storage system configured to store, maintain and shelter a mobile robot, the storage system comprising

a storage device according to any of the embodiments A1 to A31; and

a mobile robot comprising

a body comprising an item space; and

a battery; and

a robot processing component; and

a robot communication component; and

a server;

wherein the server is configured to communicate with the storage device and with the mobile robot.

S2. The storage system according to the preceding embodiment wherein the storage device is configured to replace the battery of the mobile robot.

S3. The storage system according to any of the preceding system embodiments wherein the mobile robot is configured to navigate to the storage device by using the robot processing component.

S4. The storage system according to any of the preceding system embodiments wherein the mobile robot is configured to request access to the storage device by using the robot communication component.

S5. The storage system according to the preceding embodiment wherein the mobile robot is configured to communicate with the server to request access to the storage device and the server is configured to communicate with the storage device to request the storage device to open the port.

S6. The storage system according to any of the preceding system embodiments and with the features of embodiment S4 wherein the mobile robot is configured to communicate with the storage device to request access and the storage device is configured to communicate with the server to authorize the request.

S7. The storage system according to any of the preceding system embodiments and with the features of embodiment A30 wherein the mobile robot is configured to detect the identification component of the storage device.

S8. The storage system according to any of the preceding system embodiments configured to perform maintenance of the mobile robot when the mobile robot is located inside the enclosed space of the storage device.

S9. The storage system according to any of the preceding system embodiments wherein the storage device is configured to communicate to the server information relating to at least one of diagnostic status of the mobile robot, conditions inside the enclosed space of the housing, and conditions of the surroundings of the storage device.

S10. The storage system according to any of the preceding system embodiments further comprising a data storage unit.

S11. The storage system according to the preceding embodiment wherein the data storage unit is configured to receive data from the mobile robot.

S12. The storage system according to the preceding embodiment wherein the data storage unit is configured to receive data from the mobile robot via a short-range communication protocol.

S13. The storage system according to any of the preceding three embodiments wherein the data storage unit is configured to be removably fitted inside the enclosed space of the storage device's housing.

S14. The storage system according to the preceding embodiment wherein the data storage unit further comprises a connection port configured to receive power from the storage device.

S15. The storage system according to any of the five preceding embodiments wherein the data storage unit further comprises an identification component.

S16. The storage system according to the preceding embodiment wherein the identification component comprises a display configured to display at least status of the data storage unit.

S17. The storage system according to any of the seven preceding embodiments wherein the data storage unit further comprises at least one data unit sensor.

S18. The storage system according to the preceding embodiment wherein the data unit sensor is configured to detect physical state of environment around the data storage unit.

S19. The storage system according to any of the preceding system embodiments and with the features of embodiment S10 wherein the data storage unit is configured to communicate with the server.

S20. The storage system according to any of the preceding system embodiments and with the features of embodiment S10 wherein the data storage unit is configured to receive or store the data in encrypted manner.

S21. The storage system according to any of the preceding system embodiments and with the features of embodiment S10 wherein the data storage unit is to receive the data in a manner pre-encrypted by the robot.

Below is a list of method embodiments. Those will be indicated with a letter “M”. Whenever such embodiments are referred to, this will be done by referring to “M” embodiments.

M1. A method for at least one of storing and maintaining a mobile robot, the method comprising providing a storage device according to any of the embodiments A1 to A31;

the mobile robot approaching the storage device;

the mobile robot communicating a request to access the storage device;

the storage device opening the port to allow the robot ingress and closing it once the robot is inside;

the storage device performing at least one maintenance operation on the mobile robot;

communicating a request to leave the storage device;

the storage device opening the port to allow the robot egress and closing it once the robot is outside.

M2. The method according to the preceding embodiment wherein performing a maintenance operation comprises at least one of

swapping a battery of the mobile robot;

charging a battery of the mobile robot;

inspecting the mobile robot visually;

subjecting the mobile robot to a temperature change;

providing calibration for at least one of mobile robot's sensors; and

cleaning the mobile robot.

M3. The method according to any of the preceding method embodiments further comprising providing a system according to any of the embodiments S1 to S9.

M4. The method according to the preceding embodiment wherein the robot communicates the request to access the storage device to the server; and

the server communicates the request to the storage device.

M5. The method according to any of the preceding method embodiments and with the features of embodiment M3 wherein

the robot communicates the request to access the storage device to the storage device; and

the storage device communicates the request to the server; and

the server authorizes the request before the storage device opens the port.

M6. The method according to any of the preceding embodiments and with the features of embodiments A30 and M3 further comprising, prior to the mobile robot communicating the request for access, the mobile robot identifying the storage device by detecting the identification component.

M7. The method according to any of the preceding method embodiments and with the features of embodiment M3 further comprising the storage device reporting to the server on the status of the mobile robot and the maintenance operation to be performed once the mobile robot is inside the storage device.

M8. The method according to any of the preceding method embodiments and with the features of embodiment M3 further comprising the storage device communicating to the server at least one of conditions inside of the enclosed space and conditions of the surroundings of the storage device.

M9. The method according to any of the preceding method embodiments wherein the request to leave the storage device is communicated by the mobile robot to the storage device.

M10. The method according to any of the preceding method embodiments and with the features of embodiment M3 wherein the request to leave the storage device is communicated by at least one of the mobile robot and the storage device to the server.

M11. The method according to any of the preceding method embodiments and with the features of embodiment M3 wherein the request to leave the storage device is communicated by the server to at least one of the mobile robot and the storage device.

M12. The method according to any of the preceding method embodiments further comprising, once the mobile robot is inside the storage device, transferring data from the mobile robot to a data storage unit fitted to the storage device.

M13. The method according to any of the preceding method embodiments further comprising pre-encrypting the data in the mobile robot before it is transferred to the data storage unit.

M14. The method according to any of the preceding method embodiment further comprising decrypting the date in the server by means of a key that is accessible by the server only.

M15. The method according to any of the preceding method embodiment further comprising the mobile robot sending also data to the data storage when no data storage transport unit is available.

M16. The method according to any of the preceding method embodiment further comprising matching a data storage transport unit to a particular data storage unit by the data storage unit find the data storage transport unit once it's reachable in a wired or a wireless network.

M17. The method according to the preceding method embodiment further comprising the data storage unit constantly issuing mDNS queries to find any data storage transport unit, if present.

M18. The method according to any of the preceding method embodiment further comprising the data storage transport unit automatically detecting if it is in the proper location or position where it can upload the data to the server or multiple servers.

M19. The method according to the preceding method embodiment further comprising the data storage transport unit comparing the local network properties preferably by a default gateway hardware address against a pre-configured list of valid addresses and finding a match automatically and then uploading it's content.

Below is a list of data storage unit embodiments. Those will be indicated with a letter “U”. Whenever such embodiments are referred to, this will be done by referring to “U” embodiments.

U1. A data storage unit configured to be fitted to a storage device according to any of the embodiments A1 to A35, the data storage unit comprising

a data storage drive; and
a data unit communication component configured to communicate via at least one short-range protocol.

U2. The data storage unit according to the preceding embodiment configured to be removably attached to inside of the storage device's enclosed space.

U3. The data storage device according to any of the two preceding embodiments further comprising a connection port configured to receive power from the storage device.

U4. The data storage device according to any of the preceding four embodiments wherein the data unit communication component is further configured to wirelessly communicate via medium and/or long-range communication protocol.

U5. The data storage device according to any of the preceding five embodiments wherein the data storage drive is configured to store data received via the short-range protocol.

The present technology will now be discussed with reference to the accompanying drawings.

### BRIEF DESCRIPTION OF THE DRAWINGS

FIG. 1 depicts a schematic embodiment of a storage device 1 according to one aspect of the invention;

FIG. 2 depicts a schematic embodiment of the storage device 1 with a mobile robot 100 inside according to one aspect of the invention;

FIG. 3 schematically depicts two storage devices 1, 1′ side by side with one being exited by a mobile robot 100;

FIG. 4 depicts another schematic embodiment of the storage device 1 according to one aspect of the invention;

FIG. 5 schematically depicts an embodiment of the mobile robot 100 configured to use the storage device;

FIGS. 6a, 6b and 6c schematically depict some possible communication configurations between the mobile robot 100, the storage device 1 and a server 200;

FIG. 7 depicts an embodiment of a method of storing and maintaining a mobile robot 100 according to one aspect of the invention;

FIGS. 8a, 8b, 8c, and 8d depict another embodiment of a storage device 1 according to one aspect of the invention;

FIG. 9 depicts an optional data storage unit that can be used with the storage device; and

FIG. 10 depicts an embodiment of the storage device with the optional data storage unit integrated with it.

### DESCRIPTION OF EMBODIMENTS

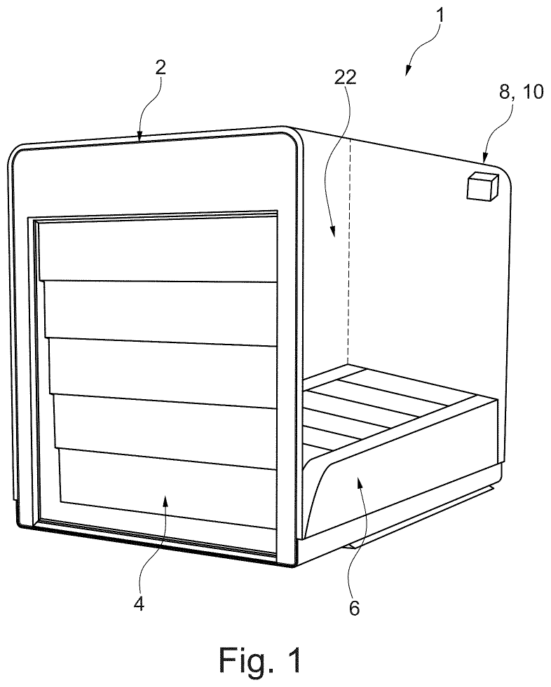

FIG. 1 schematically depicts an embodiment of the storage device 1 according to one aspect of the invention. The storage device can preferably serve to house, shelter and maintain a mobile robot. The mobile robot can be preferably configured to operate in outdoors environments. The storage device 1 can also be preferably configured to be installed in outdoor environments: such as on the streets, in public spaces, on business premises and/or on private properties. The storage device 1, which can also be referred to as a pod 1, can also be installed indoors or integrated into a building if needed. The storage device can be impermeable to weather, such as able to withstand strong winds, waterproof to a degree sufficient to withstand rain or snow, and substantially dustproof and/or sand proof. The storage device 1 can also be preferably sufficiently resilient to withstand vandalism and/or collisions caused by weather and/or accidents. The storage device 1 can weigh between 100 and 500 kg. The dimensions of the storage device 1 can preferably comprise a length of 100 to 1500 cm, preferably 500 to 1200 cm, a height of 300 to 1000 cm, preferably 500 to 800 cm, and a width of 300 to 1500 cm, preferably 500 to 1000 cm.

The storage device 1 comprises a housing 2. The housing 2 can be made of one piece or comprise a plurality of connected parts. The housing 2 can comprise a port 4. The port 4 can be configured to open and close autonomously and/or automatically. That is, the port 4 can opened and closed by the storage device 1, without manual intervention from a human or otherwise. The housing 2 comprises an enclosed space 22. The enclosed space 22 can be surrounded by the housing 2 on all sides. The enclosed space 22 can be accessed via the port 4 when it is opened. The storage device 1 further comprises electronics including a processing component 8 and a communication component 10, depicted schematically in the figure as a box.

The housing 2 can at least partially comprise a material permeable to electromagnetic waves in the radio spectrum. This material can comprise an acrylic, or an acrylic-mineral composite. For example, the material can comprise Corian®. The housing 2 can preferably comprise several pieces attached together. For example, the side walls (the ones perpendicular to the port 4) and the top part can comprise one piece, and the bottom, front and back walls can attach onto it.

The port 4 is depicted on the figure as being composed of interconnected slats. FIG. 1 shows the port 4 in a closed position. The port 4 can open vertically (that is, by moving up along the housing), so that the slats move inside the storage device 1 along the ceiling of the enclosed space. A different configuration, with the slats being vertical, and the port 4 opening horizontally is also possible. The port 4 can also comprise a mesh, for example a mesh composed of a metal alloy. The port 4 can comprise a lock, preferably an electronic lock that can be opened autonomously by a command from the processing component 8.

The battery station 6 can comprise a ramp that a mobile robot can climb while entering the port and descend on when exiting it. The battery station 6 can be as described in the applicant's European patent application 17173098.9, incorporated herein by reference. The battery station 6 can comprise a battery swapping device that can swap the mobile robot's battery with a fresh one. The battery station 6 can also have one or more charging stations, where mobile robot batteries can be charged.

The processing component 8 can comprise a standard CPU unit. The processing component 8 can be configured to control the operation of the storage device 1. That is, the processing component 8 can control the opening and closing of the port 4, any maintenance performed on the mobile robot when it is inside the storage device 1, the surveillance of the surroundings of the storage device (when needed), the turning on of any lights on the outside and inside of the housing 2 and further features. The communication component 10 can be integrated with the processing component 8 or can comprise a separate device. The communication component 10 can comprise one of more of at least one of a SIM card and a modem.

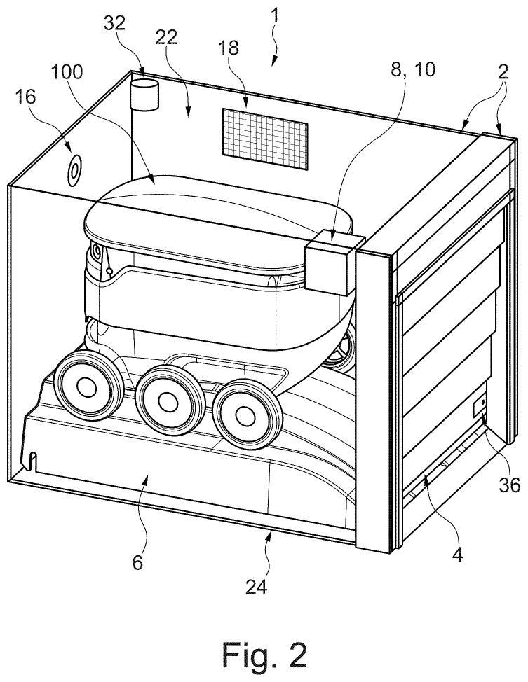

FIG. 2 schematically depicts an embodiment of the storage device 1 with the mobile robot 100 inside the enclosed space 22. As before, the storage device 1 comprises the housing 2. In the present figure, the part of the housing 2 comprising the port 4 is shown as a separate part attached to the other part of the housing 2.

Several optional elements that can be present together or separately are also depicted in FIG. 2.

A diagnostic sensor 16 is schematically shown on the inside of the housing 2, facing the enclosed space 22. The diagnostic sensor 16 can serve to observe the enclosed space 22 and/or the mobile robot 100 and detect any irregularities. For example, the diagnostic sensor 16 can comprise a visual camera that can capture the outer appearance of the mobile robot 100 to detect any anomalies such as damage, dirt, or similar irregularities. The diagnostic sensor 16 can also comprise different sensors or a plurality of sensors placed in different places inside the enclosed space 22. The data captured by the diagnostic sensor 16 can be processed by the processing component 8, by the mobile robot 100 (that is, by its own robot processing component, not shown here), or be sent elsewhere via the communication component 10 (and/or via the robot's communication component, also not shown in the figure), for example to a remote server. The diagnostic sensor 16 can also comprise a temperature/humidity sensor detecting temperature and/or humidity inside the enclosed space, as well as a fire and/or smoke detector and/or a flood detector. The diagnostic sensor 16 can also comprise a smoke detector, an accelerometer, a gyroscope, a flood detector and/or an infrared detector.

Also shown is a calibration component 18. The calibration component 18 can comprise, for example, a calibration pattern that can be used to calibrate the mobile robot's sensors. For example, the calibration component 18 can comprise a pattern of parallelograms of different colors, so that the corners between them can be uniquely identified and used by the robot's cameras for self-calibration. The calibration component 18 can also comprise a different device.

Also shown is a temperature control component 32. Depicted schematically as a box, the temperature control component 32 can comprise a heater and/or an air conditioner. It can be used to adjust the temperature within the enclosed space when the outside temperature is too cold or too hot (and therefore can affect operation of the storage device and/or affect the mobile robot 100 or its components such as the battery). The temperature component can also comprise a ventilation shaft that can be opened or closed as necessary. The temperature component can also be controlled by the processing component 8.

On the outside of the housing, housing bottom part 24 is depicted. The housing bottom part 24 can comprise a specially designed lower part, which is particularly configured to be lifted and transported by standard transporting equipment. That is, the housing bottom part can comprise a convenient gripping surface and/or have fasteners that can be easily gripped.

Also depicted on the outside of the housing is an identification component 36. The identification component 36 can comprise a barcode, a QR code, an ArUco code, a color code, an image, an RFID tag and/or other similar codes or devices that can be read off easily. The mobile robot 100 approaching the storage device 1 can then read off this code to identify the storage device 1 that it should enter.

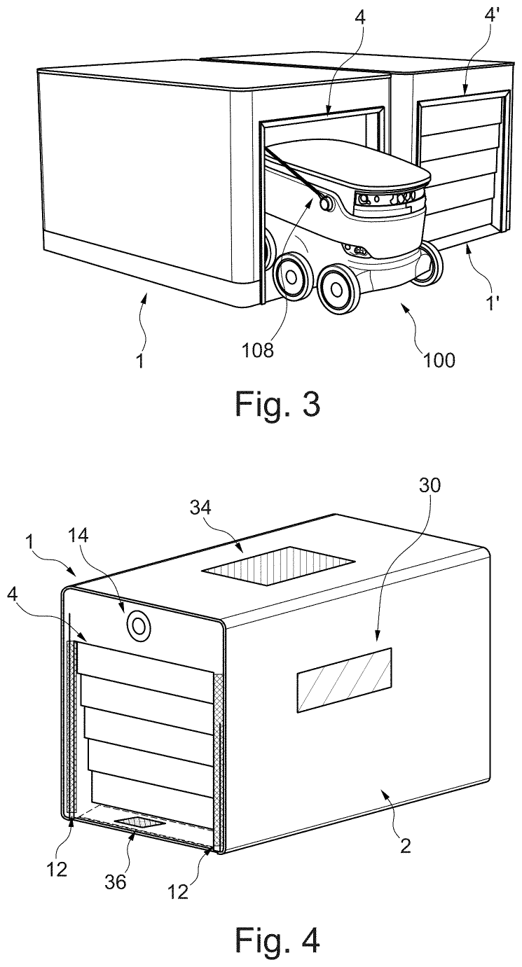

FIG. 3 depicts two storage devices 1 and 1′ side by side. A plurality of storage devices 1, 1′ can be deployed at the same location. Since one storage device 1 can preferably shelter one mobile robot 100 (although up to five robots 100 can be sheltered by bigger the storage devices 1), it can be beneficial to have several storage devices 1 at a location where a plurality of mobile robots 100 can use them. The identification component 36 can be particularly useful in this scenario. FIG. 3 shows the port 4 of the storage device 1 open, and the port 4′ of the storage device 1′ closed. The port 4 opens in such a way that the slates comprising it retract inside the storage device 1 rather than protruding on the outside.

FIG. 3 also shows the mobile robot 100 entering or exiting the storage device 1. The mobile robot 100 comprises a robot signaling device 108. This can be a flexible flagpole or antenna used to improve the visibility of the mobile robot 100. The storage device 1 can comprise a track (or a similar device) along which the robot signaling device 108 can slide when the mobile robot 100 enters or exits the storage device, so that it does not get stuck or damaged during ingress and egress.

The storage devices 1, 1′ can also be attached to each other or stacked on top of each other for easy and convenient transportation.

FIG. 4 depicts another schematic embodiment of the storage device 1 with further optional features and add-ons that can be used in combination or separately.

The storage device 1 as depicted comprises an illumination component 12. The illumination component 12 can comprise one or a plurality of light-emitting sources. In FIG. 4, the illumination component 12 is depicted as two strips of lights (such as LEDs) running along the sides of the port 3. One strip of lights or another configuration of lights is also possible. The illumination component 12 can be used to illuminate the port 4, so that the mobile robot 100 can better identify where it should enter the storage device 1. The illumination component 12 can also be used to illuminate the identification component 36 in case it is a visual identification element (such as a QR code). The illumination component 12 can also be used to illuminate the surroundings of the storage device, for example to detect a threat or inhospitable conditions (such as vandals, difficult passage to the port 4 due to weather or other factors and other possible conditions/events). The illumination component 12 can be configured to turn on automatically in the presence of motion (when combined with an infrared or a different motion sensor) or to be turned on and off by the processing component 8 of the storage device.

Also depicted in FIG. 4 is a detection sensor 14. The detection sensor 14 can comprise a visual camera, an infrared camera or motion detector, an ultrasonic sensor, a time-of-flight camera, or another sensor. The detection sensor can also comprise an accelerometer, a gyroscope, a fire and/or smoke detector, a flood detector, a vandalism detecting system, a weather station and/or a combination of those. There can be a plurality of similar or different detection sensors 14 placed in different locations on outside of the housing 2. The detection sensor 14 can serve to observe the surroundings of the storage device 1 in order to detect approaching people, animals, mobile robots 100, the weather or other possible events/surrounding conditions.

Further depicted in FIG. 4 is a communication terminal 30. The communication terminal 30 can comprise a screen, a touchscreen, a microphone, a speaker and/or other possible devices for communication. The communication terminal 30 can be used to communicate to interested persons the purpose of the storage device 1. The communication terminal 30 can be located on the outside of the housing 2, embedded into the housing 2, inside a special compartment on the housing 2 or similarly placed so that it can be accessed from the outside of the housing 2 for communication with people.

On the top of the housing 2, an energy generating component 34 is shown schematically. The energy generating component 34 can comprise a solar cell, a wind turbine, a small generator, or a similar energy source. It can be integrated into the electrical grid or preferably be independent. The energy generating component 34 can be used to power the storage device 1, particularly its various sensors, diagnostic devices, the processing component 8, and the communication component 10.

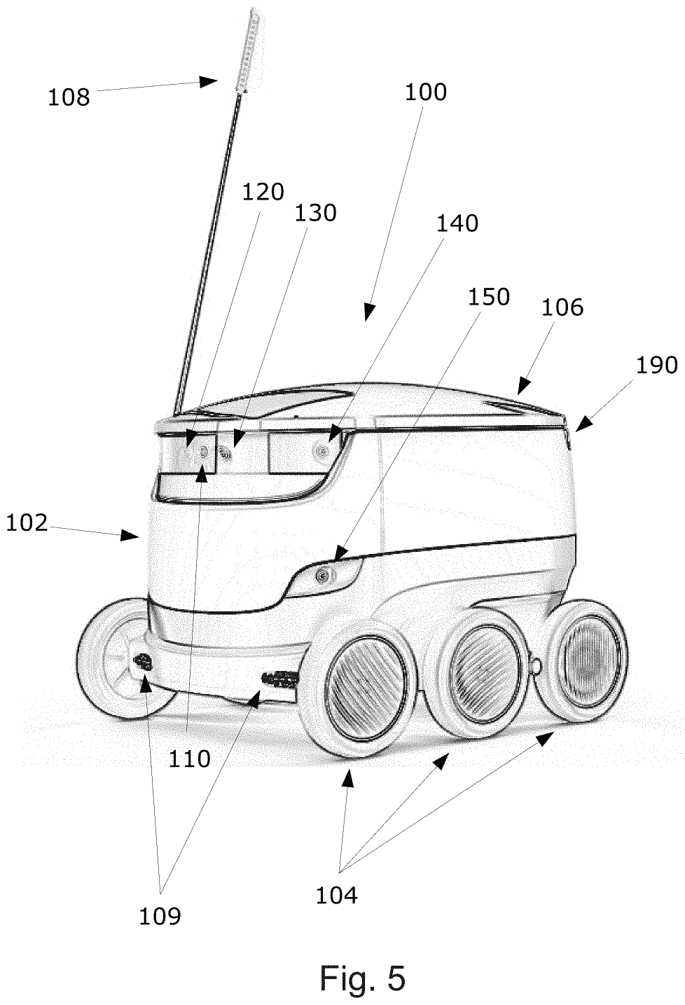

FIG. 5 demonstrates an exemplary embodiment of the mobile robot 100 configured to transport items. The mobile robot 100 can comprise a delivery or a vending robot, that is, it can transport and deliver packages, consumable items, groceries or other items to customers.

The mobile robot 100 comprises a robot body 102. The body 102 comprises an item compartment in which items can be placed and transported by the robot (not shown in the present figure).

The mobile robot 100 further comprises a robot motion component 104 (depicted as wheels 104). In the present embodiment, the motion component 104 comprises six wheels 104. This can be particularly advantageous for the mobile robot 100 when traversing curbstones or other similar obstacles on the way to delivery recipients.

The mobile robot 100 comprises a robot lid 106. The lid 106 can be placed over the item compartment and locked to prevent unauthorized access to the items the mobile robot 100 is carrying.

The mobile robot 100 further comprises a robot signaling device 108, depicted here as a flagpole or stick 108 used to increase the visibility of the robot 100. Particularly, the visibility of the robot 100 during road crossings can be increased. In some embodiments, the signaling device 108 can comprise an antenna. The mobile robot 100 further comprises robot headlights 109 configured to facilitate the robot's navigation in reduced natural light scenarios and/or increase the robot's visibility further. The headlights are schematically depicted as two symmetric lights 109, but can comprise one light, a plurality of lights arranged differently and other similar arrangements.

The mobile robot 100 also comprises robot sensors 110, 120, 130, 140, 150, and 190. The sensors are depicted as visual cameras in the figure, but can also comprise radar sensors, ultrasonic sensors, Lidar sensors, time of flight cameras and/or other sensors. Further sensors can also be present on the mobile robot 100. One sensor can comprise a front camera 110. The front camera 110 can be generally forward facing. The sensors may also comprise front, side and/or back stereo cameras 120, 130, 140, 150, 190. The front stereo cameras 120 and 130 can be slightly downward facing. The side stereo cameras 140 and 150 can be forward-sideways facing. There can be analogous side stereo cameras on the other side of the robot (not shown in the figure). The back stereo camera 190 can be generally backward facing. The sensors present on multiple sides of the robot can contribute to its situational awareness. That is, the robot 100 can be configured to detect approaching objects and/or hazardous moving objects from a plurality of sides and act accordingly.

The robot sensors can also allow the robot 100 to navigate and travel to its destinations at least partially autonomously. That is, the robot can be configured to map its surroundings, localize itself on such a map and navigate towards different destinations using in part the input received from the multiple sensors.

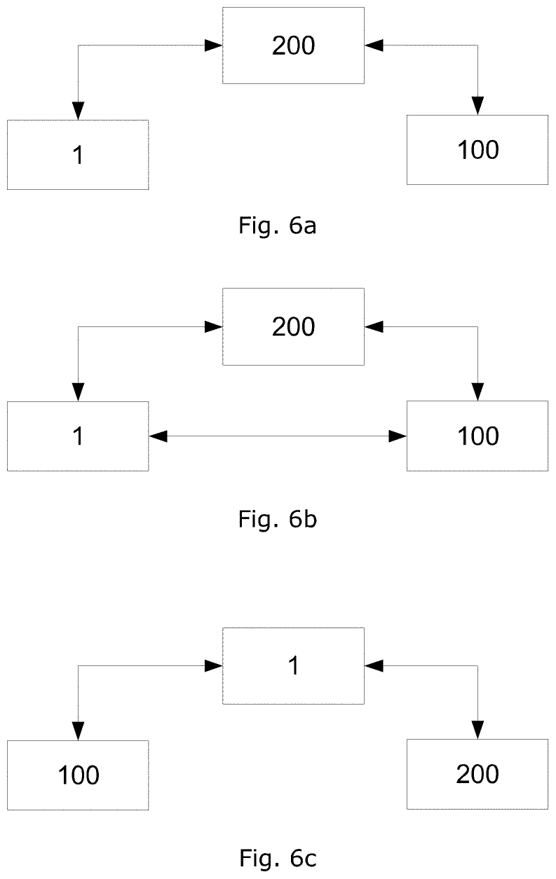

FIGS. 6a, 6b and 6c depict possible configurations of communication between a storage device 1, a mobile robot 100 and a server 200. The server 200 can be a remote server coordinating the operations of a plurality of mobile robots 100 and storage devices 1.

FIG. 6a depicts a configuration where the server 200 centrally coordinates all communication between the robot 100 and the storage device 1. The mobile robot approaching the storage device 1 would send the server 200 a request for ingress or entry into the storage device 1, and the server 200 would send the command to allow access to the storage device 1.

FIG. 6b depicts a similar configuration where also direct communication is possible between the mobile robot 100 and the storage device 1. For example, if the connection to the server 200 is not reliable, the storage device 1 and the mobile robot 100 can switch to direct communication. This hybrid communication can also be useful when the robot 100 is inside the storage device 1. For instance, the robot 100 can directly communicate with the battery station 6 inside the storage device 1 or directly communicate with the storage device 1 regarding the diagnostics and maintenance procedures.

FIG. 6c depicts a configuration where the mobile robot 100 and the server 200 communicate with the storage device 1. This configuration can be particularly useful when the storage device 1 comprises a wired or a more reliable communication component than the robot, so that it can transmit the robot's messages to the server 200. The robot 100 and the storage device 1 can communicate via a different communication channel such as Bluetooth®, NFC or similar.

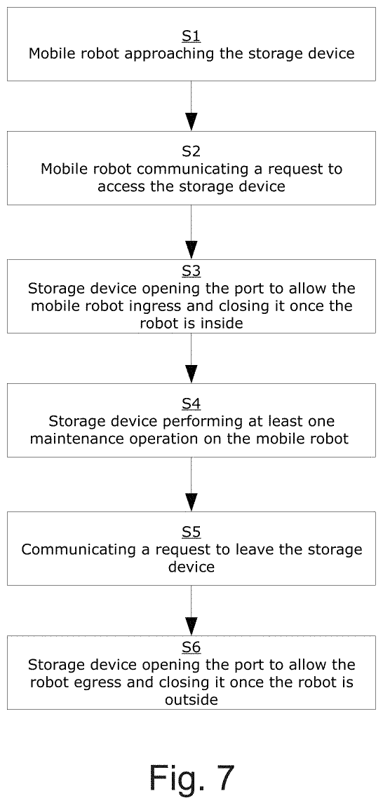

FIG. 7 depicts an embodiment of a method for storing and maintaining a mobile robot 100. In S1, the mobile robot approaches the storage device. That is, the mobile robot can be in need of a new battery, other maintenance or simply storage during a period where it is not needed to transport items or make deliveries.

In S2, the mobile robot communicates a request to access the storage device. The request can be communicated to a server or to the storage device directly.

In S3, the storage device opens the port to allow the mobile robot ingress or entry and closes the port once the robot is inside. In this way, the robot can safely be stored inside the storage device without unauthorized persons having access to it.

In S4, the storage device performs at least one maintenance operation on the mobile robot. The maintenance operation can comprise swapping a battery of the mobile robot, charging a battery of the mobile robot, inspecting the mobile robot visually, subjecting the mobile robot to a temperature change (that is, heating or cooling the enclosed space or a particular part of the robot, for example for deicing), providing calibration for at least one of mobile robot's sensors (for example a plurality of visual cameras), and cleaning the mobile robot (for example wiping its sensors).

In S5, a request to leave the storage device is communicated. This request can originate from the mobile robot, the storage device or the server. That is, the mobile robot can communicate to the server or to the storage device that it requests egress from the storage device. Additionally or alternatively, the storage device can communicate to the server that there is a mobile robot in its enclosed space and that egress is requested to the server. Additionally or alternatively, the server can communicate to the storage device that the egress of the mobile robot is requested.

In S6, the storage device opens the port to allow the robot egress or exit and closes it once the robot is outside.

Note, that whenever opening and closing of the port is referenced in the present disclosure, also locking and unlocking can be implied.

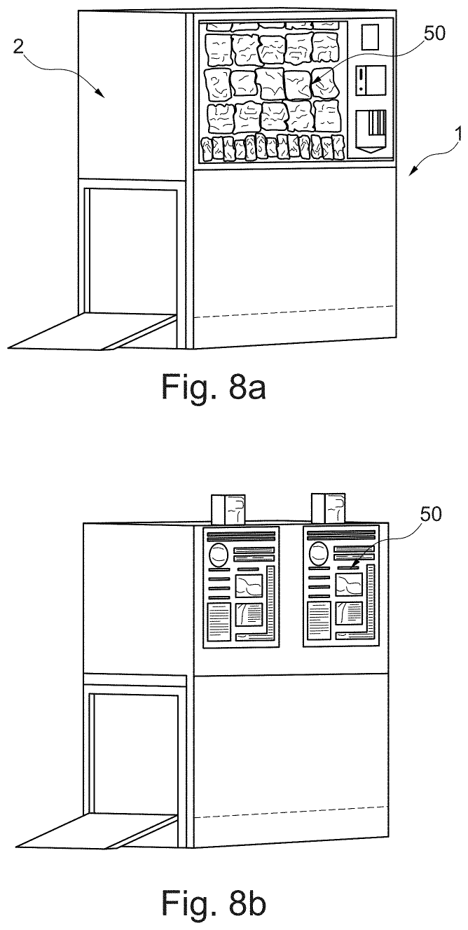

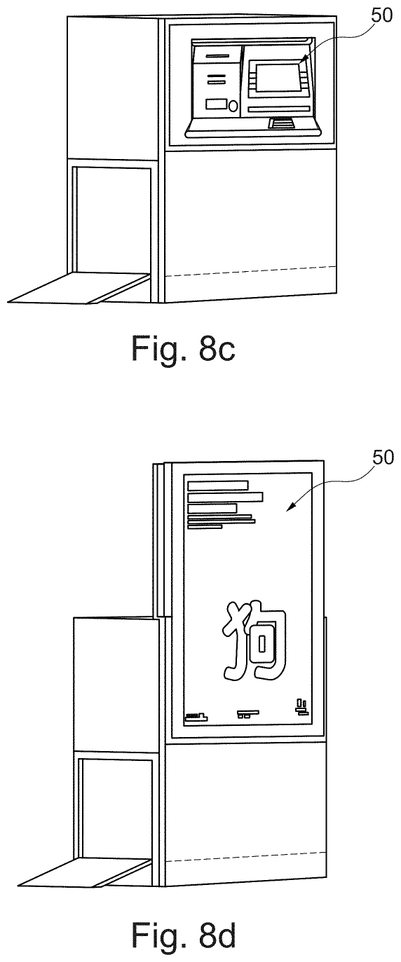

FIGS. 8a, 8b, 8c, 8d depict another embodiment of the storage device 1. It is shown as integrated with several public use devices 50 generally found around cities and streets.

In FIG. 8a, the top part of the storage device's body 2 comprises a vending machine 50 where users can purchase snacks, beverages and/or other items.

In FIG. 8b, the storage device 1 is integrated with a newspaper distributor 50. The users can use the top part of the body to purchase and/or to retrieve various newspapers.

In FIG. 8c, the storage device 1 is integrated with an automated teller machine (ATM) 50. The users can use the machine to deposit checks, withdraw money and/or perform other operations typical of an ATM.

In FIG. 8d, the storage device 1 is integrated with a billboard 50. Interested parties may display advertisements on the billboard and/or the billboard may be used to advertise the mobile robot and/or the storage device.

All of the embodiments in FIGS. 8a-8d are exemplary and need not be necessary. As shown in previous figures, the storage device can comprise a free standing device configured for housing a mobile robot. However, integrating the storage device or pod with public use devices 50 comprising familiar objects can be advantageous to increase social acceptance, optimize the use of space on the streets and in public cities, and organically integrate the storage device into its surroundings. Furthermore, since the storage device is preferably located at the ground level, it can be useful to integrate it with a device that would be preferably located higher up, such as at ATM machine, so that it can be conveniently reached by users.

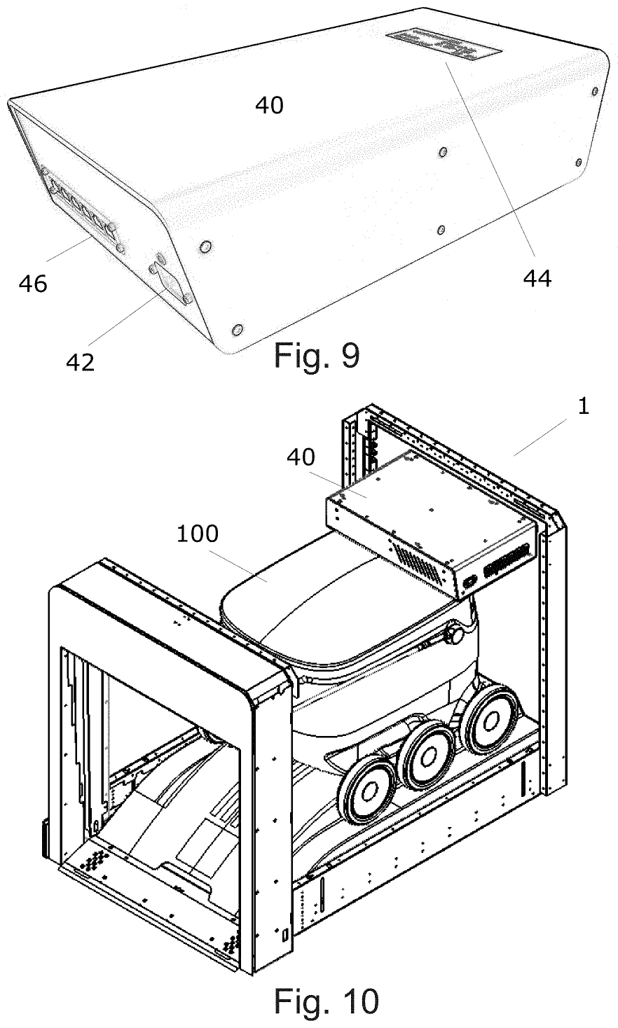

FIG. 9 depicts an embodiment of a data storage unit 40 that can be optionally used together with the storage device 1.

The data storage unit 40 can comprise a self-contained and separate device that can be used as a standalone unit, or in combination with the storage device 1. The data storage unit 40 can comprise a component configured to record and store digital data, preferably large amounts of digital data. For example, the data storage unit 40 can comprise a hard disk drive, a solid-state drive or the like. The amount of data that can be stored by the data storage unit 40 can be on the order of 500 GB to a few TB of data.

A preferred use for the data storage unit 40 may comprise the mobile robot 100 communicating with it and transferring a part or all of the data it collected over a certain time interval into the data storage unit 40. In other words, the data storage unit 40 may serve as an external memory drive for the mobile robot 100. This can allow the mobile robot to avoid transferring large amounts of data over mobile connection and/or over the storage device's connection. The mobile robot 100 can generally accumulate large amounts of data during its operations. Such data can comprise sensor data, including images from a plurality of visual cameras, which might comprise a significant volume of digital data. The robot 100 may have limited internal data storage, so that excess data may need to be transferred and/or deleted. The data storage unit 40 can ensure that the robot's data is preserved without the mobile robot 100 having to send it to a remote server 200 or the like.

The data storage unit 40 can also comprise a connection port 42. Such a connection port can be used for wired connection with the storage device 1 or a source that the storage device 1 is also connected to. The connection port 42 can preferably generally be used for supplying power to the data storage unit 40. A wired connection may be advantageous, as it can allow for continuous power supply without the need to recharge the data storage unit 40.

The data storage unit 40 can also comprise an identification component 44. The identification component 44 may be used to identify the particular data storage unit 40 and match it to a particular storage device 1 and/or a particular robot 100. The identification component 44 may comprise a serial number, a barcode or the like, or, it can also comprise a display where various parameters associated with the data storage unit 40 may be shown. Such parameters may comprise, for example, percentage of free storage, identification of the robot 100 that has transferred its data to the data storage unit 40, diagnostic parameters and/or the like.

The data storage unit 40 may also further comprise data unit sensors 46. These may comprise physical condition sensors configured to sense the temperature, humidity or the presence of smoke within the immediate surroundings of the data storage unit 40. Additionally or alternatively, the data unit sensors 46 may be particularly configured to detect any physical conditions that may be specifically detrimental to the data storage unit 40, for instance the temperature rising above a certain predetermined threshold.

The data storage unit 40 also preferably comprises a data unit communication component (not shown in the figure), which can be used for communication with the storage device 1 and/or the mobile robot 100. The communication component may be configured to communicate via different communication protocols such as WLAN, WiFi, Bluetooth, NFC or the like. Particularly, there may be a short range communication protocol (such as Bluetooth) which is preferably used for the data transfer from the mobile robot 100 to the data storage unit 40. This can allow for seamless and secure data transfer.

Due to its bandwidth WLAN is presently best for sending data from robots.

Furthermore, the data storage unit 40 may also comprise a modem or a similar component configured to provide wireless network signal. The mobile robot 100 and the storage device 1 may connect to the internet via this wireless network signal.

FIG. 10 depicts the storage device 1 with the data storage unit 40 attached to it. The placement of the data storage unit 40 towards the top back part of the storage device 1 is exemplary, but the data storage unit 40 is preferably attached to or placed on the inside of the storage device 1. In this way, the proximity between the data storage unit 40 and the mobile robot 100 using the storage device 1 can allow for quicker, more efficient and safer data transfer between the two. Particularly, the mobile robot 100 can transfer the data collected by its sensors to the data storage unit 40. This can occur either at the end of the day, or at the end of the mobile robot's shift, or at predetermined time intervals according to the internal storage capacities of the mobile robot 100 and the amount of data it collects.

The data storage unit 40 may be regularly replaced within the storage device 1. In other words, once the data storage unit 40 accumulates a certain amount of data from the mobile robot 100, it may be physically removed from the storage device 1, and replaced by a new unit, which can then be filled with the robot's data in turn. The physical removal and replacement of the data storage unit 40 may allow for subsequent data transfer from the data storage unit 40 to a remote server 200. This can preferably take place via a wired connection between the data storage unit 40 and the remote server 200 (that is, the data storage unit 40 may be brought to the vicinity of the remote server 200). This can allow for avoiding large data transfer via wireless or mobile networks, ensuring its safety and allowing for an efficient procedure.

The data storage unit 40 may be connected to the storage device 1 or to its source of power for energy supply. The data storage unit 40 and the storage device 1 may communicate via the remote server 200. Such communication may comprise, for example, verification of the sensor data between storage device's sensors and (if present) the data storage unit's sensors. The communication between the data storage unit 40 and the mobile robot 100, however, is preferably done directly, via a short-range communication protocol. In this way, the data transferred from the mobile robot 100 to the data storage unit 40 need not be sent to the remote server 200.

The data storage unit 40 may be removably attached to the inside of the storage device 1. In this way, the data storage unit 40 may be removed and reattached as needed after receiving sufficient data from the mobile robot 100 and to exchange a full data storage unit 40 with a fresh one.

Additionally or alternatively, the data storage unit 40 may be connectable to a separate data storage transport unit. The data storage transport unit may receive data stored on one or a plurality of data storage units 40, and serve as an intermediary data storage medium between the data storage unit 40 and the server 200. For this purpose, the data storage transport unit may first be physically transported to a location where one or more data storage units 40 are present, where their data may be transferred either via a wired connection or a local wireless connection. Then, the data storage transport unit may be physically brought to the location of the server 200, where the data can similarly be transferred to the server 200 via wired or local wireless connection. This can also advantageously allow for safe and seamless data transfer while allowing the data storage unit 40 to remain installed within the storage device 1.

The mobile robot can also send data to the data storage, although no data storage transport unit is available.

There is no need to match a data storage transport unit to a particular data storage unit—the data storage unit can find the data storage transport unit once it's reachable in a wired or a wireless network, e.g., by constantly issuing mDNS queries to find any data storage transport unit, if present.

The data storage transport unit in turn automatically detects if it is in the proper location or position where it can upload the data to the server or multiple servers. It's doing so by comparing the local network properties, e.g. by a default gateway hardware address, against a pre-configured list of valid addresses. Thus, it can find a match automatically and upload it's content. This approach allows to bring data storage transport unit to any uploading location without the need to match them.

### LIST OF REFERENCE NUMERALS

1 Storage device

2 Housing

4 Port

6 Battery station

8 Processing component

10 Communication component

12 Illumination component

14 Detection sensor

16 Diagnostic sensor

18 Calibration component

22 Enclosed space

24 Housing bottom part

30 Communication terminal

32 Temperature control component

34 Energy generating component

36 Identification component

40 Data storage unit

42 Connection port

44 Identification component

46 Data unit sensors

50 Public use device

100 Mobile robot

102 Robot body

104 Robot motion component

106 Robot lid

108 Robot signaling device

109 Robot headlights

110, 120, 130, 140, 150, 190 Robot sensors

200 Server

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be the preferred order, but it may not be mandatory to carry out the steps in the recited order. That is, unless otherwise specified or unless clear to the skilled person, the order in which steps are recited may not be mandatory. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

We claim:

1. A storage device configured to store, maintain, and/or shelter a mobile robot, the storage device comprising:
a housing comprising an enclosed space configured to house at least one mobile robot; and
a port located in the housing and configured to open to let the mobile robot enter or exit the enclosed space of the housing; and
a battery station configured to swap a battery of the mobile robot; and
a processing component; and
a communication component.

2. The storage device according to claim 1 wherein the port is configured to open and close vertically or horizontally in a plane of the port.

3. The storage device according to claim 1 wherein the battery station is further configured to perform at least one of
charging the battery of the mobile robot, and/or
charging additional batteries.

4. The storage device according to claim 1 wherein the communication component is configured to communicate with the mobile robot and wherein the processing component is configured to open the port upon the communication component receiving a request from the mobile robot.

5. The storage device according to claim 1 further comprising at least one detection sensor located on the outside of the housing and configured to detect surroundings of the storage device.

6. The storage device according to claim 1 further comprising at least one diagnostic sensor located on the inside of the housing and configured to inspect at least one of: (i) the mobile robot, and/or (ii) the inside of the storage device.

7. The storage device according to claim 1 further comprising a communication terminal comprising at least one of: a display, a microphone, and/or a speaker configured for communication with third parties.

8. The storage device according to claim 1 further comprising an identification component.

9. The storage device according to claim 1 further comprising at least one calibration component configured to calibrate sensors of the mobile robot.

10. A storage system configured to store, maintain, and/or shelter a mobile robot, the storage system comprising:
a storage device according to any claim 1; and
a mobile robot comprising
a body comprising an item space; and
a battery; and
a robot processing component; and
a robot communication component; and
a server,
wherein the server is configured to communicate with the storage device and with the mobile robot.

11. The storage system according to claim 10, wherein the mobile robot is configured to request access to the storage device by using the robot communication component.

12. The storage system according to claim 10 wherein the mobile robot is configured to perform at least one of
communicate with the server to request access to the storage device and the server is configured to communicate with the storage device to request the storage device to open the port; and
communicate with the storage device to request access and the storage device is configured to communicate with the server to authorize the request.

13. The storage system according to claim 10 and wherein the storage device comprises an identification component wherein the mobile robot is configured to detect the identification component of the storage device.

14. A method for at least one of storing and maintaining a mobile robot, the method comprising
providing a storage device according to claim 1;
the mobile robot approaching the storage device;
the mobile robot communicating a request to access the storage device;
the storage device opening the port to allow the mobile robot entry and closing the port once the mobile robot is inside;
the storage device performing at least one maintenance operation on the mobile robot;
communicating a request to leave the storage device;
the storage device opening the port to allow the mobile robot to exit and closing the port once the mobile robot is outside.

15. The method according to claim 14 wherein performing a maintenance operation comprises at least one of:
swapping a battery of the mobile robot;
charging a battery of the mobile robot;
inspecting the mobile robot visually;
subjecting the mobile robot to a temperature change;
providing calibration for at least one of mobile robot's sensors; and/or
cleaning the mobile robot.

16. The method according to claim 14 further comprising providing a system comprising:
the storage device; and
a communication component; and
a mobile robot comprising
a body comprising an item space; and
a battery; and
a robot processing component; and
a robot communication component; and
a server;
wherein the server is configured to communicate with the storage device and with the mobile robot.

17. The method according to claim 16 wherein
the mobile robot communicates the request to access the storage device to the server; and
the server communicates the request to the storage device.

18. The method according to claim 16 wherein
the mobile robot communicates the request to access the storage device to the storage device; and
the storage device communicates the request to the server; and
the server authorizes the request before the storage device opens the port.

19. The method according to claim 16, wherein the storage device comprises an identification component, the method further comprising:
prior to the mobile robot communicating the request for access, the mobile robot identifying the storage device by detecting the identification component.

20. The method according to claim 16 further comprising:
the storage device reporting to the server on a status of the mobile robot and the maintenance operation to be performed once the mobile robot is inside the storage device.

21. The method according to claim 16 further comprising:
the storage device communicating to the server at least one of: (i) conditions inside of the enclosed space, and/or (ii) conditions of the surroundings of the storage device.
